(19) United States
(12) Patent Application Publication
(10) Pub. No.: US 2013/0098527 A1
(43) Pub. Date: Apr. 25, 2013

(54) ROTOR BLADE FORM FOR PRODUCING A ROTOR BLADE OF A WIND POWER PLANT

(71) Applicants: Stephan Harms, Upgant-Schott (DE); Uwe Kolbe, Timmel (DE); Torsten Overlander, Hesel-Beningafehn (DE)

(72) Inventors: Stephan Harms, Upgant-Schott (DE); Uwe Kolbe, Timmel (DE); Torsten Overlander, Hesel-Beningafehn (DE)

(73) Assignee: WOBBEN PROPERTIES GMBH, Aurich (DE)

(21) Appl. No.: 13/638,581

(22) PCT Filed: Mar. 30, 2011
(86) PCT No.: PCT/EP11/54958

§ 371 Date: Jan. 2, 2013

(30) Foreign Application Priority Data
Mar. 30, 2010 (DE) 10 2010 013 405.8

(51) Int. Cl. F03D 1/06

(52) U.S. Cl. CPC F03D 1/0675
USPC 156/64; 156/499; 156/60; 156/367

(57) ABSTRACT

The present invention concerns a rotor blade mold for producing a rotor blade of a wind power installation or a part thereof comprising a heatable mold portion having a shaping surface for shaping the rotor blade surface and wherein the heatable mold portion has at least two heating portions and each heating portion includes at least one electrical resistance heating element arranged at or beneath the shaping surface and a supply unit for supplying the at least one resistance heating element with electrical heating current.

### BACKGROUND

1. Technical Field

The present invention concerns a rotor blade mold for producing a rotor blade of a wind power installation and a method of producing a rotor blade of a wind power installation.

2. Description of the Related Art

Rotor blades of modern wind power installations attain sizes of 60 m in length, 5 m in width and 2 m in thickness and can possibly be even still larger. To achieve high stability with low weight such a rotor blade is frequently made from a fiber-reinforced plastic, in particular glass fiber-reinforced plastic (GRP). That includes the aspect that components of other materials can be included in the rotor blade, such as for example a trailing edge of metal or reinforcement materials in the rotor blade of wood. The predominant part of the rotor blade, in particular the shaping shell or shell portion thereof is however made from fiber-reinforced plastic. For that purpose, at least one rotor blade mold is used, which basically forms a negative shape for the rotor blade surface to be produced. In that respect the rotor blade can be composed for example of two half-shells, wherein the half-shells are each previously produced in a dedicated rotor blade mold for same. Depending on the respective size of the rotor blade to be produced it is also possible to provide more than two molds.

To produce the rotor blade or rotor blade portion, for example resin-impregnated fiber cloths, in particular woven cloths, are placed in the mold in order then to harden and to assume a surface in accordance with the rotor blade mold. The rotor blade mold is heated to speed up the hardening procedure and/or to make it uniform. In that respect, uniform heating or possibly locally targeted heating as required is to be implemented to harden the rotor blade.

For that purpose known rotor blade molds for producing a rotor blade of a wind power installation or a part thereof have a pipe conduit system through which the warm or hot water is passed to warm the rotor blade mold. The heat is spread from that pipe conduit system heated in that way by way of the body of the rotor blade mold to the surface thereof towards the material to be hardened.

Such a heating system is really complicated and expensive in terms of production of the rotor blade mold provided therewith and complicated and expensive in terms of use as besides heating the water it is also necessary to provide for circulation thereof. In addition such a system has a comparative degree of inertia.

Furthermore, the problem of exothermy can occur when hardening resin. In that case in the hardening operation the resin gives off heat to the environment, and that can lead to unwanted and uncontrolled heating and possibly overheating. Sometimes it is only possible to inadequately counteract that phenomenon by interrupting the feed of further hot water.

### BRIEF SUMMARY

Therefore an object of the present invention is to improve a rotor blade mold for producing a rotor blade of a wind power installation or a part thereof and a corresponding method such that at least one of the aforementioned problems is reduced or eliminated. In particular the invention seeks to provide a solution for improving the heating process when producing a rotor blade of a wind power installation. At least the invention seeks to propose an alternative solution.

There is proposed a rotor blade mold for producing a rotor blade or a part thereof.

In accordance therewith the rotor blade mold has a heatable mold portion having a shaping surface for shaping the rotor blade surface. Resin-impregnated fiber cloths like glass fiber cloths or the like are appropriately placed on that shaping surface which is usually of a concave configuration for producing the rotor blade surface.

The heatable mold portion has at least two heating elements having at least one respective electrical resistance heating element. Provided for each heating portion is its own supply unit for supplying the respective resistance heating element with electric current for heating purposes. The use of electrical resistance heating elements is intended to make it possible to in particular dynamically introduce the heating power. Electrical resistance heating elements can be of a more compact nature in comparison with a pipe conduit system. As a result it is on the one hand possible for the direct heating source to be respectively disposed closer to the shaping surface or even to be arranged directly at the shaping surface. In addition, a structure of the rotor blade mold can be of a more compact configuration and/or can be lighter in terms of weight. The use of a plurality of heating zones permits locally targetedly directed application of heat. Thus for example regions can be especially heated. That can be meaningful for example for a chord area which especially heats a region of the rotor blade, that is provided with a chord portion, or an edge area can be especially heated. In addition it may be that different regions of the rotor blade mold and/or the rotor blade give off heat to differing levels of strength, because for example they are thermally insulated to differing degrees in relation to the environment. In order nonetheless to achieve uniform or more uniform temperature distribution it may be advantageous for such more poorly insulated regions to be supplied with more heating power per surface area. When using more than two heating portions selected regions can also be covered by more than one heating portion and different heating portions can be grouped in time-wise relationship, in respect of a common task. In addition heating regions can overlap.

The provision of separate supply units permits the heating portions to be heated independently of each other. Expressed in concrete terms, switching a heating portion on or off does not influence the feed of heating power of another heating portion. In other words, decoupling of the heating portions is achieved by the provision of separate supply units, in respect of the heating effect.

Complete thermal decoupling of regions which are adjacent in terms of location cannot be absolutely achieved thereby, but taking account of such influences can sometimes be simplified thereby.

By using separate supply units for individual heating portions it is also possible to use standard elements. At any event when each heating portion can basically absorb or requires a similar amount of heating power, it is possible to use an identical, in particular structurally identical, supply unit for each heating portion. It would therefore only be necessary to develop a single supply unit and a corresponding number of supply units is used according to the respectively present heating portions. In that way it is also possible to develop only a single supply unit even for rotor blade molds of differing sizes. In that case the increased heating requirement of a larger rotor blade mold in comparison with a smaller one could be easily achieved by the provision of correspondingly more heating portions and/or correspondingly more supply units.

Each supply unit includes a control unit for controlling the electric current for heating the respective resistance heating element, preferably a transformer or current setting device for providing the heating current. The term current setting device is used here to denote a unit which by means of semiconductor switches provides the desired current, such as for example an inverter, a controlled rectifier, a booster converter or a buck converter. The output voltage of such a transformer or current setting device—and therewith the input voltage of the resistance heating element in question—can be for example up to 40 V.

The current for heating the heating portion or resistance heating element in question can be specifically targetedly controlled by the control unit. In the simplest case this involves switching the current supply on or off. Likewise, in a further embodiment, the amplitude of the current can be controlled.

The voltage for supplying the respective resistance heating element can be adjusted and adapted thereto by a transformer. In that case the transformer can provide different voltage tappings in order thereby to produce different voltages and accordingly different currents and heating power levels. In a variant the control unit controls corresponding transformer tappings in order thereby to regulate the heating power. In principle regulation of the supply of power is also possible by pulsing of the current supply. The control unit and/or the transformer is matched to the electrical resistance heating element or elements to be supplied. In particular the transformer is of corresponding dimensions. In accordance with an embodiment there is provided a respective transformer with different voltage tappings, of which however only one is connected. Preferably the transformers of the rotor blade mold are identical for each of the supply units, but are connected differently in accordance with the respective resistance heating element to be heated, in particular to different voltage tappings.

Preferably each supply unit has a switch cabinet with control unit and transformer, if present. In principle parts of those units can also project out of the switch cabinet, in particular any cooling plates. Preferably however the supply unit is in the form of a compact unit, by virtue of the switch cabinet. The compact supply unit can be appropriately positioned at a desired position of the rotor blade mold. In that respect it is to be repeated that a modern rotor blade and thus a rotor blade mold for a wind power installation can be of a length of 60 m. For low-voltage circuits, that is to say the secondary side of any transformer, short connecting lines are therefore advantageous. Accordingly each supply unit can be positioned as closely as possible to the respective heating portion to be supplied.

Preferably a rotor blade mold is characterized in that the control unit or a part thereof, optionally also a current setting device, is mounted to a removable outside wall portion of the switch cabinet which can also be referred to for simplicity as a removable housing wall, and electric connections in relation to that outside wall portion are provided in the form of releasable connections to simplify replacement of that outside wall portion including the elements mounted thereon, by another outside wall portion. In spite of the most careful manufacture of a supply unit, in particular a corresponding switch cabinet, faults can occur in the electronic system, in particular the control unit, or faults can occur later. Those faults can involve problems in the software and also in the hardware. In accordance with this configuration a control unit can be easily replaced by the housing wall with the defective control unit being simply replaced by another housing wall with the same but non-defective control unit. A corresponding consideration applies for a current setting device. In that way it is possible to deal with a fault as quickly as possible during production and to prevent the production of a reject component, that is to say the rejection of a rotor blade or a part thereof. By virtue of the comparatively long production process and in particular the procedure for hardening a rotor blade of a wind power installation, it may be sufficient to replace a control unit within the context of a few minutes. Longer periods of time may also be acceptable, depending on the respective progression in manufacture.

Such a simple replacement option can also be achieved if the control system or the current setting device, instead of being mounted to a complete housing wall, is mounted to a part thereof or another easily accessible load-bearing portion of the switch cabinet.

A further configuration proposes that the rotor blade mold is characterized by a central control for outputting reference or target values and/or switching commands to each of the supply units or the control unit of each supply unit, wherein there is provided a data communication between the central control and each supply unit and/or between the supply units with each other.

The entire heating requirement for the entire rotor blade mold can be coordinated by the central control. That makes it possible to achieve coordinated heating of the rotor blade mold, that is as uniform as possible, in particular to heat the entire rotor blade portion to be produced with the rotor blade mold. Thus for example temperature target values for each heating portion can be predetermined by way of the central control unit and communicated to the supply unit in question. Each supply unit can then suitably individually control the heating power. The data can be transmitted by way of a data communication between the central control and each supply unit and/or between the supply units with each other. In other words, there can be provided a star-shaped topology or a ring-shaped topology. With a ring-shaped topology, for example all target values for all heating portions can be transmitted, starting from the central control, from one supply unit to the next, in which case each supply unit takes the target value relevant for it from a corresponding data packet. The data communication can in that case be wired and also by way of radio.

The transmission of switching commands from the central unit to the supply units, which can be effected additionally or alternatively, also provides for control and in particular regulation centrally in the central control. The central control can thus centrally control the heating of the entire rotor blade mold and match same to each other. The specific provision of the electric current for heating the rotor blade mold is however implemented by the respective supply units. Actual values and in particular actual temperature values for the heating portions are passed to the central control unit. That can be effected by way of the respective supply units. Conversion of analog temperature measurement values into digital values for transmission and/or processing in the central control unit is often already effected by the respective temperature measuring sensor.

In addition, it is possible to provide in the central control unit a data logger which records measurement data of the respective manufacturing method and is not to be manipulated.

Preferably the at least one resistance heating element is in the form of a flat heating element and can thus heat surfaces in correspondingly targeted fashion. Additionally or optionally the heating element is formed from carbon fibers or carbon filaments or has such fibers. Such carbon fibers can conduct electric current in the sense of an electric resistance and in that case heat up. Such a configuration is particularly advantageous for the situation where the rotor blade mold is formed substantially from carbon fiber-reinforced plastic material in the region of the shaping surface of the mold. More specifically in that case the rotor blade mold in that region and the heating element also to be arranged in that region have similar mechanical properties like strength or also temperature-dependent properties like properties determined by a coefficient of expansion. In that respect a rotor blade mold of carbon fiber-reinforced plastic does not necessarily also have to have a heating element of carbon fibers.

A rotor blade mold of a further embodiment is characterized by a carrier portion, in particular a lattice carrier or lattice girder, for carrying the heatable mold portion, and a bus bar which is arranged on the carrier portion and which connects the supply units for supplying the supply units or the transformers with electric current and/or data. Such a carrier portion, in particular a lattice carrier or lattice girder, basically carries the portion of the rotor blade mold, that has the shaping surface.

In a structural variant there is a heatable shaping layer for example of carbon fiber-reinforced plastic (GRP) to which there is connected an electrically insulating layer, followed by a thermally insulating layer which can be of a honeycomb structure. Adjoining the thermally insulating layer is for example a further stabilizing GRP layer. That sandwich structure, from the shaping layer to the further stabilizing layer, can in total be of a thickness in the region of some cm, for example about 5 cm. That sandwich structure is finally carried by the carrier portion.

The carrier portion can be provided in particular over the entire length of the rotor blade to be produced or a part thereof and is adapted for being set up on a floor of a workshop. Preferably it is in the form of a lattice structure and can be of a height of for example 1 to 2 m. Basically, a layer adapted to the rotor blade mold to be produced is arranged on such a lattice structure, in particular in the manner of the above-described sandwich structure. That layer which is adapted in the mold is not capable of bearing load on its own over the entire rotor blade length and is thus supported and held on said carrier portion, in particular the lattice carrier or lattice girder.

That carrier portion, in particular the lattice carrier or lattice girder, is also fitted in this embodiment with a bus bar. That bus bar is used to supply the supply units and/or the transformers or rectifiers. Preferably those transformers or rectifiers form a part of the supply unit and each supply unit can be connected to the bus bar at the location of the supply unit, more specifically in the proximity of the heating portion associated therewith. Optionally or alternatively the bus bar performs the function of feeding data to each supply unit. Preferably such a bus bar has an electric supply line, also referred to as the energy bus, for the transmission of electric energy, and a data line, also referred to as the data bus, for the transmission of data. The data bus can also be provided separately. In that way the carrier portion, in particular the lattice carrier or girder, can be equipped upon construction of the rotor blade mold with a bus bar to which then the supply units are connected and fixed at the desired locations. That makes it possible for even the structure of a rotor blade mold 60 m in length to be of an at least partially modular configuration. A rotor blade mold which is otherwise of a highly individual configuration, with many different individual regions, can thereby be equipped with a multiplicity of standardized elements so that fewer different elements are required and even the steps for equipping the mold can be in part standardized.

Preferably each heating region has at least one temperature sensor and the temperature sensor is connected to the supply unit in question for the transmission of measured temperature measurement values and the supply unit is adapted to evaluate the respective measurement values. Such a temperature measurement sensor thus supplies in particular electric and/or digitized values to the supply unit, which are correspondingly further transmitted and/or evaluated. In that way the heating power level can be controlled and for example a temperature target value which is predetermined by a central control unit can be attained by regulation. For evaluation purposes, there is provided the or a control unit which can put the thermal measurement values in intermediate storage and introduce them into a control algorithm. In that case one or more temperature sensors such as for example a Pt100 can be provided, in which case the temperature sensors can be evaluated differently. It is thus proposed that the results of one or more temperature sensors are used for the general control of the heating elements and thus for the supply of current, whereas a further temperature sensor or temperature detector is provided exclusively for limitation purposes. That is to say such a temperature sensor provided for limitation purposes delivers its values substantially only to a safety unit which monitors the maintenance of a maximum temperature value. Such a temperature sensor can also be referred to as a temperature limiter. In an embodiment the temperature limiter is of such a design configuration that it directly performs a switching procedure, such as for example a bimetal switch.

It is desirable if the current and/or voltage of the resistance heating element are measured. By virtue thereof, with a known temperature characteristic in respect of the resistance heating element, it is also possible to determine its temperature. For example such a procedure for determining temperature can also be used as redundancy measurement in relation to a temperature measurement operation with a temperature sensor.

Preferably, for each heating portion, a current target value and/or a switching command is passed by a central control to the supply unit in question for controlling a current by means of a or the transformer or current setting device for heating the at least one resistance heating element. In that way the control and evaluation procedures are concentrated in the central control unit. That avoids the provision of many complex microprocessors in the individual supply units. Safety circuits such as overheating protection which is implemented by a temperature limiter can be provided at each supply device.

The measurement values of the temperature sensors can however also be used for more than just direct comparison. Rather, the control unit can be adapted to also implement more complex evaluation processes and/or more complex control methods. Preferably such a control unit has a microprocessor and/or a central processor unit (CPU) in the central control unit or the supply unit.

In a variant, in particular for the production of a partial portion of a rotor blade, there is provided a rotor blade mold having only one heating region and only one supply unit.

There is also proposed a method of producing a rotor blade of a wind power installation or a part thereof. In accordance therewith a hardenable material is introduced into the rotor blade mold onto a shaping surface of a heatable mold portion of the rotor blade mold. The hardenable material used is in particular a composite fiber material like glass fiber-reinforced plastic or carbon fiber-reinforced plastic. In that respect the introduction of the hardenable material involves in particular laying resin-saturated cloths, in particular woven cloths in position, in which case possibly resin can additionally be introduced before, during and/or after positioning of the resin-saturated cloths.

In the next step the mold portion having the shaping surface is heated so that the hardenable material hardens.

In that case the hardening operation is effected using a mold portion having at least two heating portions. Each heating portion is heated by means of at least one electrical resistance heating element arranged at or beneath the shaping surface. In that way heating which is as areal as possible can be implemented in specifically targeted fashion in the proximity of the hardenable material. In that case each heating portion is supplied with electric current by means of a supply unit associated with the respective heating portion.

Preferably a rotor blade mold according to the invention is used here.

Further preferably, a temperature target value is predetermined for each heating portion by a or the central control and is transmitted to each supply unit of the respective heating portion. Each supply unit controls in itself the heating portion associated therewith to establish the temperature target value in question, that is to say to set it by control or regulation. In particular each supply unit or there the control system in question performs a target value/actual value comparison between measured and predetermined temperature and passes the result of that target value/actual value comparison, that is to say the regulating error, to a suitable regulating system for producing a setting parameter for controlling the respective heating power.

An embodiment performs the control, in particular a target value/actual value comparison, for each heating region in the central control unit and transmits only switching signals to the respective supply units.

Irrespective of where the control or regulation operation is performed, there are predetermined time-dependent temperature configurations individually in particular for each heating region. They form the basis of the described control of the heating process and can be ascertained for example by preliminary tests. Adaptation during the production of a rotor blade is possible. The control procedure optionally involves manual intervention if this seems necessary.

In a preferred embodiment the supply unit records temperature measurement values at at least one location in the heating portion in question and interrupts and/or reduces the supply of heating power in dependence on a temperature pattern. In particular in the case of an excessively great rise in temperature the supply of current for heating purposes is interrupted or at least reduced. In other words, not only is an absolute temperature value respectively taken into consideration to control the heating effect, but rather the temperature configuration and in particular a rise in temperature is taken into account. It is to be noted that a thermal characteristic usually does not oscillate. That means that temperature regulation can usually be in the form of pure Pregulation. Often a so-called two-point regulator is adequate, namely a regulator which supplies heating power as long as the desired temperature is not reached and switches off the heating power at the moment at which the desired temperature is attained.

The solution according to the invention provides that it is also possible to react well to an exothermic operation which can occur for example upon hardening of resins because rapid detection of a rise in temperature in each individual heating region and rapid shut-down of each individual heating region is made possible.

Preferably the heating operation is reduced or shut down only when the measured temperature value exceeds the calculated temperature value by a predetermined minimum value which can also be temperature-dependent. That takes account on the one hand of a measurement inaccuracy and also a calculation inaccuracy, but a so-called ping-pong effect is also avoided.

In a further embodiment the rotor blade mold and in particular the lattice girder has a connecting device, in particular a plug-in connecting device, for connection to a counterpart connecting device, in particular a counterpart plug-in connecting device, for making an electrical energy connection for the transmission of electrical energy, a data transmission connection for the transmission of data, a compressed air connection for supplying the mold heating system with compressed air and/or a vacuum transmission connection for providing a vacuum at at least one portion of the rotor blade mold. Preferably the connecting device at the same time has at least one connector or plug-in connector for the transmission of energy, a connector or plug connector for the transmission of data, a connector or plug connector for the supply with compressed air and a connector or plug connector for providing a vacuum. The rotor blade mold is preferably mobile and coupling of the overall mold heating system to a corresponding supply system for energy, compressed air and vacuum can thus be easily implemented by the connecting device. At the same time advantageous data exchange can also be effected therewith.

### BRIEF DESCRIPTION OF THE SEVERAL VIEWS OF THE DRAWINGS

FIG. 1 diagrammatically shows a plan view of a rotor blade mold according to invention for a rotor blade half-shell with emphasized heating regions and diagrammatically illustrated supply units,

FIG. 2 shows plurality of assembled rotor blade molds according to the invention as a perspective view for another rotor blade from the rotor blade mold in FIG. 1,

FIG. 3 shows a perspective view of a carrier structure identified as a lattice girder of one of the rotor blade molds in FIG. 2,

FIG. 4 shows a lattice girder with a supply unit according to the invention,

FIG. 5 shows a plan view of two lattice girders according to the invention,

FIG. 6 shows a perspective view of the lattice girders of FIG. 5,

FIG. 7 shows a side view of a plug-in connecting device,

FIG. 8 shows a side view of a counterpart plug-in connecting device adapted to the plug-in connecting device in FIG. 7, and

FIG. 9 shows a plan view of the counterpart plug-in connecting device in FIG. 8.

### DETAILED DESCRIPTION

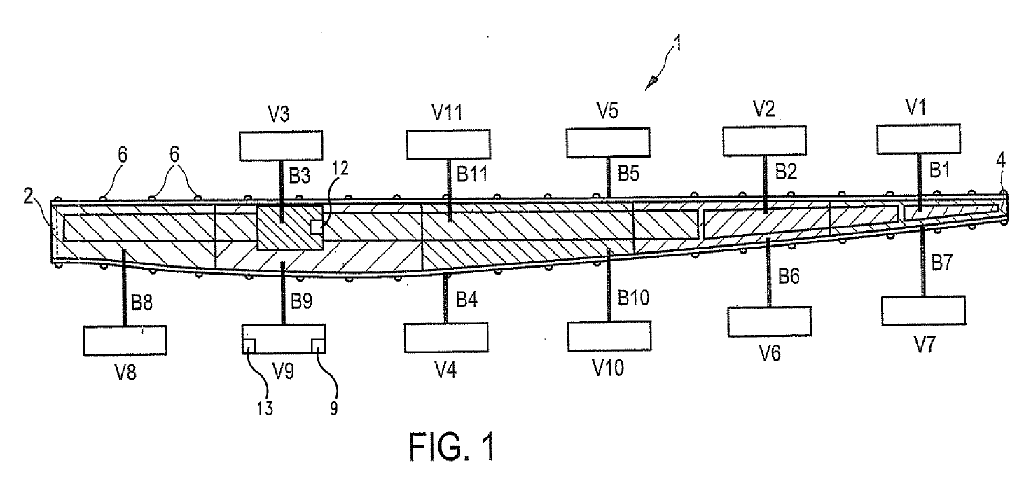

The rotor blade mold 1 in FIG. 1 is provided for producing a rotor blade half-shell. Two rotor blade half-shells can then be assembled to form a complete rotor blade after each half-shell has hardened in itself. The rotor blade mold 1 includes 11 heating regions B1 to B11 with 11 supply units V1 to V11. In accordance with the rotor blade to be produced, the rotor blade mold 1 has a root region 2 and a tip region 4, in which a root region of the rotor blade and the tip of the rotor blade are respectively correspondingly produced. FIG. 1 also shows portions of reinforcing bars 6 at their respective ends. FIG. 1 shows a view of the open rotor blade mold 1 and thus substantially a shaping surface of the rotor blade mold 1.

The rotor blade mold 1 is divided in length, namely from the root region 2 to the tip region 4, into the five main heating regions B8, B9, B10, B6 and B7. Those main heating regions achieve in particular uniform heating of the complete rotor blade mold 1 in order to heat the corresponding rotor blade half-shell entirely and uniformly for hardening purposes.

In addition, provided approximately along a longitudinal axis of the rotor blade mold are three heating regions B1, B2 and B11 to be referred to as chord areas. The chord areas B1, B2 and B11 are partially superposed in relation to the main surfaces B6 to B10. The chord areas B1, B2 and B11 are substantially arranged in a region in which a special strengthening chord or chord region is incorporated into the rotor blade to be produced. In order to especially heat that region to improve stability by said incorporated chord band, those chord areas can be heated independently. That however can also be effected at the same time with one or more of the main heating regions 6 to 10.

In addition there are provided two heating regions in the form of so-called edge areas B4 and B5. Those edge areas B4 and B5 especially heat the edge regions of the rotor blade to be produced. That makes it possible to take account of the particular demands on the rotor blade edges of the half-shell. It is to be noted in that respect that a rotor blade half-shell produced in the rotor blade mold 1 is later also assembled in particular in the region of its edges to a further corresponding rotor blade half-shell. When those rotor blade half-shells are fitted together they are glued to each other and in that case also those edge areas—and corresponding edge areas of the rotor blade mold of the other rotor blade half-shell—can be heated.

Finally, there is a further heating region as an additional edge area B3. That additional edge area B3 takes account of a region that is to be treated particularly carefully of the rotor blade to be produced. The additional edge area B3 is at least partially superposed with the main region B9 and the chord area B11.

All supply units V1 to V11 supply and respectively individually control the respective heating region B1 to B11 associated with them. Presetting values, in particular switching commands, are however supplied by a central control unit which is not shown in FIG. 1. Accordingly individual control of each heating region is however effected individually based on the externally predetermined switching values. Alternatively at least one target value and in particular a target temperature can be transmitted to the supply unit. For the control system, at least one measured temperature value is evaluated for each heating region and thus each supply unit V1 to V11, which measured temperature value can have been respectively recorded by means of a plurality of measuring sensors, such as sensor 12. Transmission of the measured temperature values is preferably effected by means of the supply units and a data bus. The actual value detected in that way is respectively compared to the predetermined target value and a corresponding setting parameter, in particular a switching command, is outputted. Each supply unit includes a control unit for controlling the electric current for heating the respective resistance heating element, and a transformer or current setting device, such as transformer or current setting device 9 in supply unit V9, for providing the heating current or each supply unit is connected to a transformer or current setting device. The supply to the respective heating region B1 to B11 with electric current for heating purposes—referred to as the heating current—is implemented by at least one transformer associated with the supply unit V1 to V11. The transformers in the supply units V1 to V11 are supplied with electrical energy by way of a bus bar. Each supply unit may include a switch cabinet 13 with control unit and transformer, if present.

In a corresponding fashion each of the supply units V1 to V11 receives only generally electrical energy from the outside, for example by way of a network connection of 235 V or 400 V, and switching commands. In addition each supply unit V1 to V11 can in turn return values, in particular also measurement values, to a central control unit. In that way it is possible for heating of the rotor blade mold 1 to be predetermined centrally at a control unit and monitored there. In particular a heating process, whether the overall heating process or partial heating processes, can also be started manually at the central control unit. All temperature values of all heating regions for example can be monitored by way of a common display. Preferably a common display is provided for that purpose, representing relevant values in an overview. Preferably such a display is provided with an input unit or is in the form of a so-called touch screen and data can be called up centrally and commands can be inputted manually in specifically targeted fashion while the supply units V1 to V11 otherwise operate individually.

It is also advantageous if such a central display and thus the central control unit overall, when using a plurality of rotor blade molds required for the production of a rotor blade, jointly represents the heating regions of all those rotor blade molds.

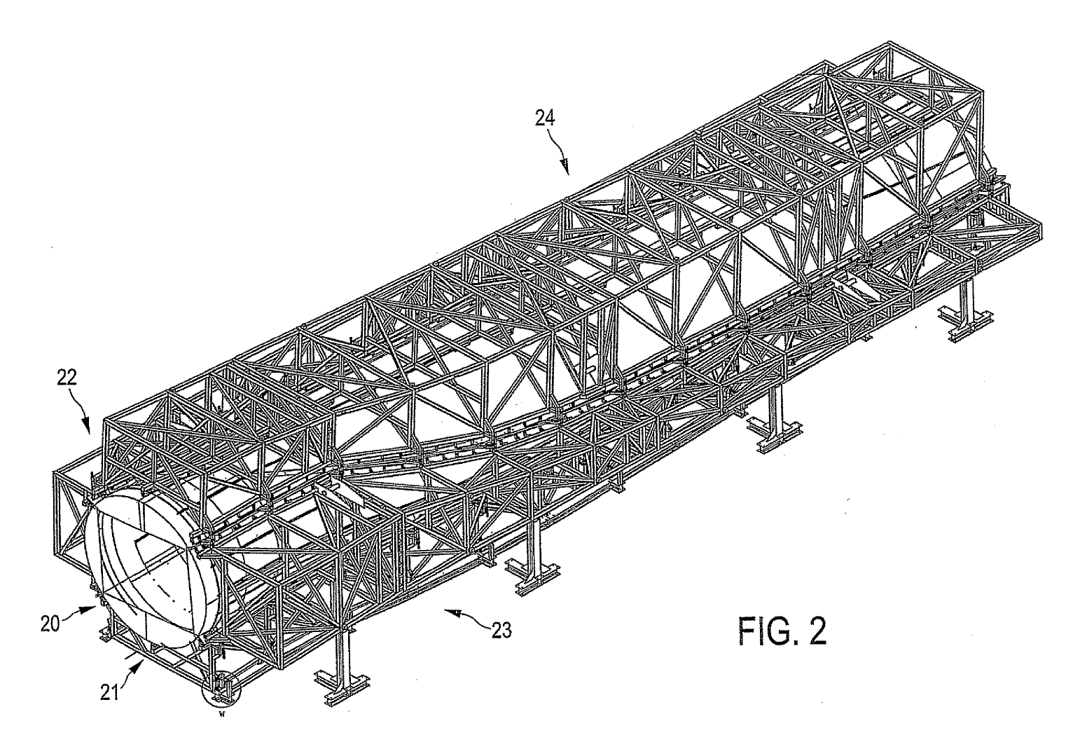

FIG. 2 shows four different rotor blade molds for a root portion of a multi-part rotor blade of a wind power installation. The root region 20 which is of an approximately round configuration for connection to a rotor blade hub is shown approximately at the left in FIG. 2. The four rotor blade molds are a rotor blade pressure side mold 21, a rotor blade nose edge mold 22, a rotor blade end edge mold 23 and a rotor blade suction side mold 24. The view in FIG. 2 shows the four rotor blade molds 21 to 24 in an assembled condition for connecting the partial regions of the rotor blade.

Individual heating regions cannot be seen in the illustrated view as they are incorporated into the respective rotor blade mold 21 to 24. Rather FIG. 2 shows substantially the carrier structure which is also referred to as the lattice girder of each rotor blade mold. The lattice girders involve substantially a framework-like configuration and can thus be produced inexpensively and are low in weight. Each lattice girder accommodates a rotor blade mold portion which has a shaping surface and into which heating elements are incorporated.

The respectively required supply units for the heating regions of each rotor blade mold 21 to 24 are not shown in FIG. 2 for enhanced clarity of the drawing.

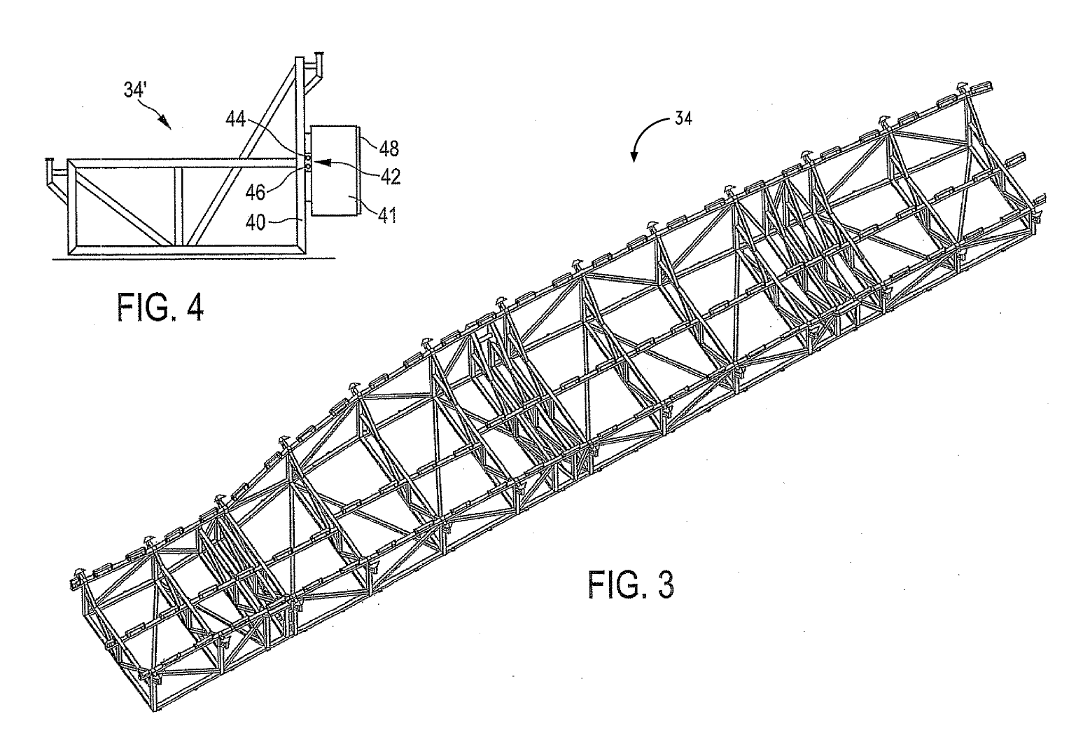

FIG. 3 shows a lattice girder 34 for the rotor blade mold 24 in FIG. 2. A rotor blade mold portion is not shown in FIG. 3 for the sake of enhanced clarity. FIG. 3 also does not show any supply units.

FIG. 4 shows a side view of a part of a lattice girder 34′. Besides structural elements of the lattice girder 34′ a bus bar 42 is arranged at a perpendicular strut 40. A supply unit 41 is also fixed at the perpendicular strut and connected to the bus bar 42.

The bus bar 42 has an energy bus 44 for providing electrical energy and by way thereof also supplies the supply unit 41 with electrical energy. In addition the bus bar 42 has a data bus 46 by way of which items of information, such as data, can be transmitted. The supply unit 41 is also connected to that data bus 46 to receive data from a central control unit and to transmit thereto. The energy bus and the data bus can also be provided separately.

In addition the supply unit 41 has a front cover 48. The control is arranged at the front cover 48, towards the interior of the supply unit 41. In the event of trouble with the control in the supply unit 41 or if such a suspicion arises, the cover 48 including the control unit arranged therein can be replaced by a further replacement front cover 48 with control unit. For that purpose it is only necessary to release a few plug-in connections between the control unit at the front cover 48 and connections in the supply unit 41.

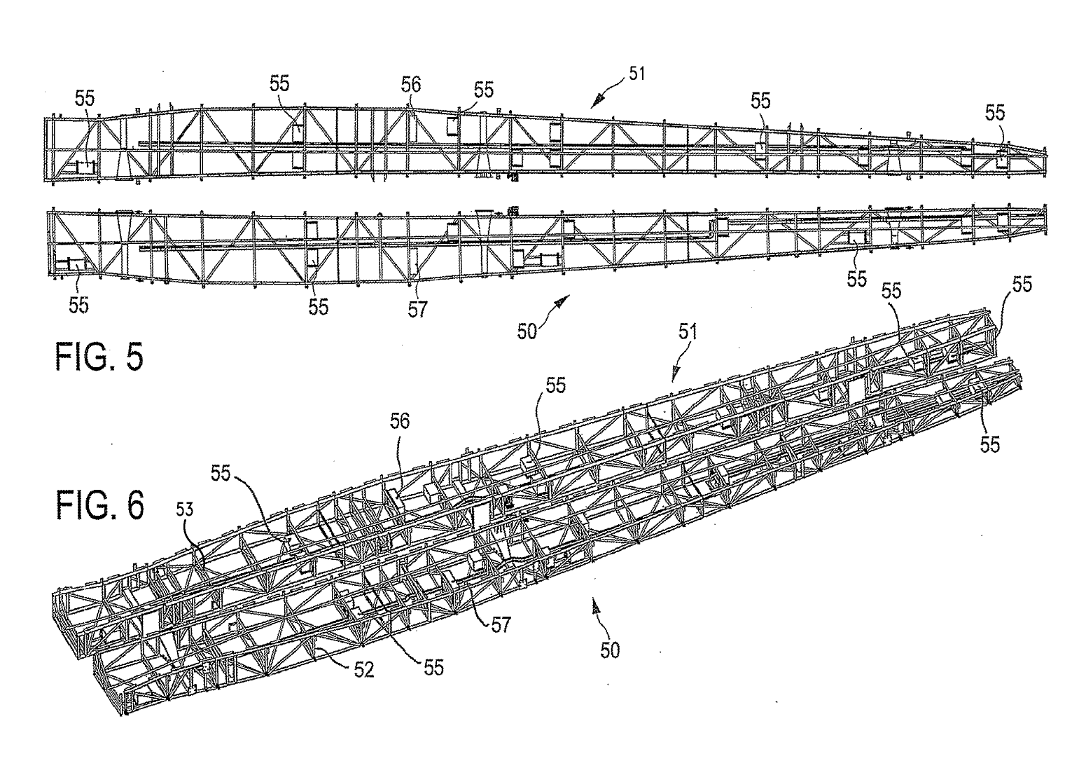

FIGS. 5 and 6 show two lattice girders 50, 51 of two rotor blade molds for producing a respective rotor blade half-shell. The lattice girders 50, 51 each have substantially a lattice structure 52, 53 in order to carry thereon a respective shaping layer in which heating elements are incorporated. That shaping layer can be joined to further layers in a sandwich structure. That shaping layer is not shown in FIGS. 5 and 6 for the sake of enhanced clarity of the drawing so that the configuration of each lattice girder 50, 51 and thus the lattice structures 52, 53 can be better seen. To supply the heating elements with electric current for heating purposes, a plurality of supply units 55 are provided for each rotor blade mold. The supply units can differ from each other in detail. Nonetheless—to enhance clarity of the drawing—identical references are used for the supply units. Each supply unit 55 supplies a respective heating region with electric current and in that case correspondingly controls the respective current to be supplied. In addition there is provided a respective central control 56, 57 to supply the supply units 55 in question with switching commands. The overall control of the respective rotor blade mold is coordinated at the central control unit 56, 57 and processes and conditions, in particular temperatures, can be represented there. Manual intervention can also be implemented by way of the central control unit.

The supply units 55 are supplied with electrical energy by way of bus bars. In addition the bus bars serve for data transmission between the supply units 55 and the central control units 56, 57. There can be a separate energy bus and a separate data bus. The supply units 55 and the central control units 56, 57 are arranged within the lattice structures 52, 53. That permits displaceability of the lattice girders 50, 51 and therewith the rotor blade molds including the central control unit 56, 57 and the supply units 55. The rotor blade mold can thus displace the location of use for example for different production steps, in which case the entire heating apparatus and control can also be moved therewith.

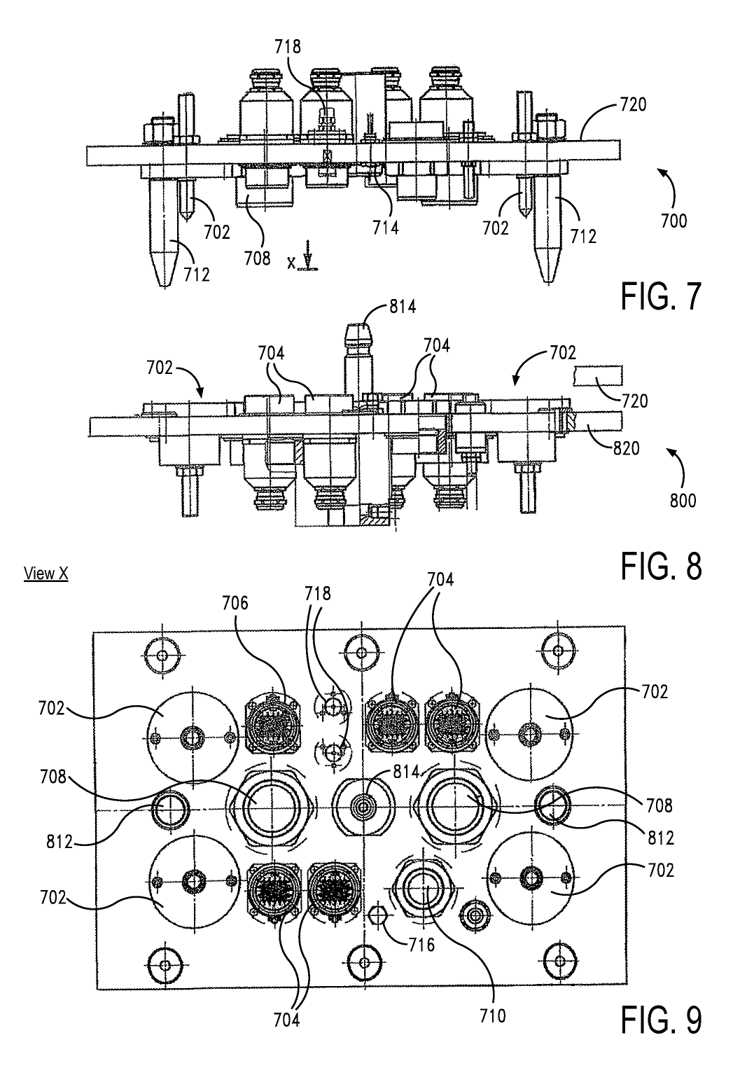

FIG. 7 shows a plug-in connecting device 700 and FIGS. 8 and 9 show a counterpart plug-in connecting device 800 corresponding thereto, in the sense of a plug and socket. The respective supply connections are denoted hereinafter with the same references for the plug-in connecting device 700 and the counterpart plug-in connecting device 800, to improve clarity. It is clear to a person skilled in the art that the respective components of the plug-in connecting device 700 and the counterpart plug-in connecting device 800 are not identical. The plug-in connecting device 700 and the counterpart plug-in connecting device 800 form a preferred connecting device 700 and counterpart connecting device 800 respectively.

The plan view in FIG. 9 shows four energy connections 702 for the transmission of electrical energy, four first data connections 704 which respectively comprise nine poles for producing a network or for coupling to a network, a 25-pole second data connection 706 for connecting the rotor blade mold in terms of control technology, namely for performing a so-called handshake of signals of control systems used, two vacuum connections 708 and a compressed air connection 710. To facilitate correct connection of the connecting device 700 to the counterpart connecting device 800 the connecting device 700 has two guide pins 712, with guide receiving means 812 corresponding thereto being provided in the counterpart connecting device 800. In that way it is also possible to avoid incorrect connection of the individual connections.

In addition there is provided a locking pin 814 to hold the connecting device 700 and the counterpart connecting device 800 in a connected and coupled condition. A contact indicator 716 is provided for detecting a connected condition of the two devices 700 and 800. Two optical fiber connections 718 are provided as a further possible way of implementing signal and data exchange respectively. The respective connections are fixedly secured to a connecting carrier plate 720 and a counterpart connecting carrier plate 820. FIG. 8 also shows a portion of the connecting carrier plate 720 which indicates the connecting carrier plate 720 in a position in which the connecting device 700 is connected to the counterpart connecting device 800.

Thus, by using the connecting device 700, which is to be provided on the rotor blade mold, it is possible to implement a connection to the counterpart connecting device 800 in a simple efficient manner, whereby supply of the rotor blade mold with electrical energy, data, compressed air and vacuum is readily possible. In regard to the data exchange, there are also provided various systems, namely a plurality of nine-pole data connections 704, a 25-pole data connection 706 and optical fiber connections 718. The mobility of the rotor blade mold which is preferably arranged movably in a workshop can also be increased thereby.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A rotor blade mold for producing a rotor blade member of a wind power installation comprising:
a heatable mold portion having a shaping surface for shaping the rotor blade member surface;
wherein the heatable mold portion has at least two heating portions and each heating portion includes at least one electrical resistance heating element arranged at or beneath the shaping surface and a supply unit configured to supply the at least one resistance heating element with electrical heating current; and
wherein each supply unit includes a control unit configured to control the heating current.

2. The rotor blade mold according to claim 1, wherein each supply unit has a switch cabinet and accommodated in the switch cabinet is the respective control unit configured to control the heating current.

3. The rotor blade mold according to claim 2, wherein at least part of the control unit mounted to a removable outside wall portion of the switch cabinet, and the control unit provides electrical connections to said outside wall portion in the form of releasable connections to simplify replacement of said outside wall portion including the elements mounted thereon by another outside wall portion.

4. The rotor blade mold according to claim 1, further comprising a central control coupled to each supply unit.

5. The rotor blade mold according to claim 1, wherein the at least one resistance heating element includes at least one of a flat heating element, carbon fibres, and carbon filaments.

6. The rotor blade mold according to claim 1, further comprising a carrier portion configured to carry the heatable mold portion, and a bus bar arranged on the carrier portion that connects the supply units with at least one of electric current and data.

7. The rotor blade mold according to claim 1, wherein each heating portion has at least one temperature sensor that is connected to the respective supply unit, each temperature sensor being configured to measure temperature values in the respective heating portion and configured to transmit signals indicative of the measured temperature values to the respective supply unit, and wherein the supply unit is adapted to evaluate the respective measured temperature values.

8. A rotor blade mold, for producing a rotor blade member of a wind power installation comprising:
a heatable mold portion having a shaping surface for shaping the rotor blade member surface;
wherein the heatable mold portion has at least one heating portion and the heating portion includes at least one electrical resistance element arranged at or beneath the shaping surface and a supply unit configured to supply the at least one resistance heating element with electrical heating current;
wherein the supply unit includes a control unit configured to control the heating current and a transformer or current setting device for providing the heating current and the at least one resistance heating element is in the form of a flat heating element and has one of carbon fibers and carbon filaments.

9. The rotor blade mold according to claim 1 further comprising: a connecting device for connection to a counterpart connecting device for making an electrical energy connection for the transmission of electrical energy, a data transmission communication for the transmission of data, a compressed air connection for supplying the mold heating with compressed air.

10. A method of producing a rotor blade member of a wind power installation in a rotor blade mold, the method comprising:
introducing a composite fiber material onto a shaping surface of the rotor blade mold;
heating the rotor blade mold to cause the composite fiber material to harden, and wherein the heating the rotor blade mold includes heating at least two heating portions in the rotor blade mold, and wherein each heating portion is heated by least one electrical resistance heating element provided at or beneath the shaping surface of the rotor blade mold, and each electrical resistance heating element is independently supplied with electric current.

11. The method according to claim 10 wherein each heating portion is controlled by a central control.

12. The method according to claim 10, further comprising:
determining a temperature target value for each heating portion; and transmitting the temperature target value to supply units associated with respective heating portions, wherein each supply unit is configured to control the heating portion associated therewith to attain the temperature target value.

13. The method according to claim 11, further comprising determining at least one of a current target value and a switching command for each heating portion.

14. The method according to claim 12, further comprising:
measuring temperature measurement values of each heating portion; and
recording the measured temperature measurement values.

15. The method according to claim 10, wherein the heating the rotor blade mold is controlled in dependence on a predetermined time-dependent temperature pattern.

16. The rotor blade mold according to claim 1, wherein each supply unit further includes at least one of a transformer and a current setting device configured to provide the electrical heating current.

17. The rotor blade mold according to claim 4, wherein the central control provides at least one of a data communication between the central control and each supply unit and a data communication between the supply unit with each other.

18. The rotor blade mold according to claim 17, wherein the central control outputs at least one of target values and switching commands to each supply unit.

19. The rotor blade mold according to claim 6, wherein the carrier portion is a lattice carrier.

20. The rotor blade mold according to claim 9, further comprising a vacuum transmission connection configured to provide a vacuum to at least one portion of the rotor blade mold.

21. The method according to claim 12, wherein the electric current is provided by each supply unit.

22. The method according to one of claims 21 wherein for each heating portion at least one current target value, and a switching command is predetermined by a central control to the supply unit in question for controlling a current by means of a transformer or current setting device for heating the at least one resistance heating element.
